(19) United States
(12) Patent Application Publication
(10) Pub. No.: US 2014/0171561 A1
(43) Pub. Date: Jun. 19, 2014

(54) METHOD FOR PRODUCING RESIN-BASED COMPOSITE MATERIAL AND METHOD FOR PRODUCING CROSSLINKED RESIN MOLDED PRODUCT

(71) Applicant: Makoto Nakabayashi, Sennan-gun (JP)

(72) Inventor: Makoto Nakabayashi, Sennan-gun (JP)

(73) Assignee: SUMITOMO ELECTRIC FINE POLYMER, INC., Sennan-gun, Osaka (JP)

(21) Appl. No.: 14/232,023

(22) PCT Filed: Aug. 31, 2012
(86) PCT No.: PCT/JP2012/072184

§ 371 Date: Jan. 10, 2014

(30) Foreign Application Priority Data
Sep. 12, 2011 (JP) 2011-198123

(51) Int. Cl. C08K 5/3492; C08K 3/22

(52) U.S. Cl. CPC C08K 5/3492; C08K 3/22
USPC 524/101; 524/606

(57) ABSTRACT

Provided are a method for producing a resin-based composite material in which a nano-filler can be easily, uniformly dispersed in a crosslinkable thermoplastic resin, and thereby, an excellent function can be imparted; and a method for producing a crosslinked resin molded product, characterized by using the resin-based composite material. A method for producing a resin-based composite material is characterized by including a step of uniformly mixing a dispersion, which is prepared by nano-dispersing a nano-filler in a liquid dispersant, with a crosslinkable thermoplastic resin. A method for producing a crosslinked resin molded product is characterized by including molding a resin-based composite material obtained by uniformly mixing a dispersion, which is prepared by nano-dispersing a nano-filler in a liquid dispersant, with a crosslinkable thermoplastic resin, and then crosslinking the resin.

### TECHNICAL FIELD

The present invention relates to a method for producing a resin-based composite material by uniformly dispersing a filler (nano-filler) including nanoparticles with a particle size much smaller than 1 μm in a crosslinkable thermoplastic resin, and a method for producing a crosslinked resin molded product using the resulting resin-based composite material.

### BACKGROUND ART

In recent years, studies have been conducted on the development of functional materials in which a nano-filler is uniformly dispersed in a resin to impart various functions to the resin. For example, Non Patent Literature 1 describes that when a nano-filler is uniformly dispersed, excellent flame retardance and a high thermal conductivity can be achieved by a small amount of dispersion compared with the case where a filler having a larger particle size is used (Non Patent Literature 1, p. 58). Furthermore, it is also described that by uniformly dispersing a nano-filler, it is possible to obtain a functional material having a high elastic modulus and a low coefficient of linear expansion while maintaining transparency (Non Patent Literature 1, p. 59).

Furthermore, methods are also known in which by crosslinking a resin, mechanical strength, heat resistance, rigidity, and the like of the resin are improved. For example, Patent Literature 1 discloses a method in which a molding composition containing a thermoplastic resin is compounded and molded, and the thermoplastic resin is crosslinked, and a transparent resin molded product obtained by the method. It is described that by crosslinking the resin, heat resistance, heat resistance during reflow soldering process, and light stability are improved, and it becomes easy to obtain excellent rigidity, excellent creep resistance, and mechanical strength, such as abrasion resistance.

Accordingly, development of a method for producing a resin-based composite material has been anticipated in which a nano-filler is uniformly dispersed in a crosslinkable resin (resin that can be crosslinked) to impart a desired function to the resin, and the resin is crosslinked so that the resulting resin-based composite material has various excellent physical properties.

### CITATION LIST

### Patent Literature

PTL 1: Japanese Unexamined Patent Application Publication No. 2010-037475

### Non Patent Literature

NPL 1: Plastics Age, April 2011, pp. 58-59

### SUMMARY OF INVENTION

### Technical Problem

In order to impart a desired function by dispersion of a nano-filler, it is desirable to disperse the nano-filler as fine particles in a base resin. Accordingly, a dispersion method in which a nano-filler can be dispersed as fine particles in a resin has been desired. It is an object of the present invention to provide a method for producing a resin-based composite material in which a nano-filler can be easily dispersed as fine particles in a crosslinkable thermoplastic resin, and thereby, an excellent function can be imparted.

### Solution to Problem

The present inventor has performed thorough studies in order to solve the problems described above. As a result, it has been found that by preparing a dispersion by uniformly dispersing a nano-filler as fine particles in a liquid dispersant, and mixing the dispersion with a crosslinkable thermoplastic resin, the nano-filler can be easily dispersed (nano-dispersed) as fine particles in the resin, and it is possible to obtain a resin-based composite material to which an excellent function is imparted. Thus, the present invention has been completed.

According to a first embodiment of the present invention, there is provided a method for producing a resin-based composite material, characterized by including a step of uniformly mixing a dispersion, which is prepared by nano-dispersing a nano-filler in a liquid dispersant, with a crosslinkable thermoplastic resin.

In the present invention, the term “nano-dispersion” refers to a state in which particles are uniformly dispersed in a dispersion medium such that the (average) size of the particles is 400 nm or less. That is, it refers to a dispersion state in which primary particles having an (average) particle size of 400 nm or less are dispersed without being aggregated and secondary particles (aggregated particles) are not formed, or a dispersion state in which the (average) size of aggregates (aggregated particles) of primary particles is 400 nm or less. Consequently, the nano-filler used in the present invention includes particles with an (average) particle size of 400 nm or less. Even in the state in which a filler with an (average) particle size of 400 nm or less is dispersed, a case where filler particles are aggregated to form aggregates with a size of more than 400 nm is not considered to be nano-dispersion. Note that the (average) particle size is a value measured by an electron microscope (SEM or the like).

In this production method, first, a dispersion is prepared by nano-dispersing a nano-filler in a liquid dispersant. The liquid dispersant is a dispersant which is in a liquid state at the temperature at the time of mixing the dispersion and the resin and in which the nano-filler can be nano-dispersed therein. Normally, the dispersion and the resin are mixed at a temperature higher than the glass transition temperature of the resin by 50° C. or more, and therefore, the liquid dispersant needs to be in a liquid state at a temperature higher than the glass transition temperature of the resin by 50° C.

The dispersion prepared as described above is mixed with a crosslinkable thermoplastic resin (matrix resin), and thereby, a resin-based composite material is produced in which the nano-filler is nano-dispersed in the crosslinkable thermoplastic resin.

As the crosslinkable thermoplastic resin (matrix resin), a thermoplastic resin or an elastomer in which polymer molecules constituting the resin can be crosslinked by heating, irradiation with ionizing radiation, or the like may be used. Specific examples thereof include various thermoplastic resins, such as polyolefins, fluororesins, polyamides, polyesters, vinyl chloride, and polystyrenes; and various elastomers, such as polyolefin elastomers, fluorine elastomers, polyamide elastomers, and polyester elastomers.

A nano-filler can be easily nano-dispersed in a matrix resin by the method of the present invention. That is, when a nano-filler is not dispersed in a liquid dispersant and is directly mixed in a matrix resin, the nano-filler is likely to form secondary particles. Furthermore, since the matrix resin has a high viscosity, there is a limit in improvement of dispersibility. By using the method in which a nano-filler is nano-dispersed in a liquid dispersant, and then the resulting dispersion is mixed with a resin, the nano-filler is satisfactorily nano-dispersed in the matrix resin.

Furthermore, when a nano-filler is dispersed in a matrix resin without using a liquid dispersant, the resin flow of the resulting resin-based composite material degrades. However, in the method for producing a resin-based composite material according to the present invention, since a liquid dispersant is used, the resin flow of the resulting resin-based composite material improves, and excellent effects can be obtained. For example, injection molding is facilitated at the time of production of a molded body using this material.

In such a manner, by nano-dispersing the nano-filler in the matrix resin with high dispersibility, various excellent functions can be imparted to the resin. Examples of the functions that can be imparted to the resin by the method for producing a resin-based composite material according to the present invention include a decrease of water absorption, a decrease of coefficient of expansion, improvement in thermal conductivity, improvement in refractive index, improvement in electrical conductivity (improvement in electromagnetic shielding property), and flame retardance.

According to a second embodiment of the present invention, in the method for producing a resin-based composite material according to the first embodiment of the present invention, it is characterized in that the dispersant is a crosslinking agent, a plasticizer, or a monomer that is polymerizable by ultraviolet light or electron beam irradiation (hereinafter, referred to as a “UV/EB monomer), which is in a liquid state at a temperature higher than the glass transition temperature of the crosslinkable thermoplastic resin (matrix resin) by 50° C.

Other components for imparting or improving various functions and physical properties can be incorporated into the resin-based composite material within the range that does not impair the object of the present invention. The other components include a crosslinking agent, a plasticizer, a UV/EB monomer, and the like. For example, when the resin is crosslinked, it is preferable to add a crosslinking agent to promote crosslinking.

In the case where the crosslinking agent, the plasticizer, and the UV/EB monomer are in a liquid state at a temperature higher than the glass transition temperature of the matrix resin by 50° C. and capable of nano-dispersing a nano-filler, they can be used as a dispersant for nano-dispersing a nano-filler to prepare the dispersion. In such a case, the components suitably used for improving various physical properties of the resin-based composite material can be directly used as a dispersant, and any component that is not required for improvement of physical properties is not added, which is preferable.

As the crosslinking agent serving as a dispersant, triallyl isocyanurate (hereinafter, referred to as “TAIC”) is preferable. TAIC has a melting point of about 23° C. and is likely to be a liquid. Furthermore, TAIC has excellent crosslinking performance because of its trifunctionality, and incorporation of TAIC allows heat resistance and heat resistance during reflow soldering process of the resin to be easily improved by ionization radiation irradiation or the like. Moreover, TAIC is preferable from the standpoint, for example, that it has relatively low susceptibility to discoloration due to radiation irradiation or heat, and has low toxicity to the human body.

In particular, when the matrix resin is a transparent resin, which will be described below, TAIC is preferable because of its high compatibility with the transparent resin. For example, TAIC is highly compatible with a transparent polyamide resin (in particular, a condensation polymer of 1,10-decanedicarboxylic acid and 3,3′-dimethyl-4,4′-diaminodicyclohexylmethane), and TAIC can be dissolved, at a high concentration of about 50% by weight, in the transparent polyamide. Consequently, a large amount of the nano-filler is easily nano-dispersed in the transparent polyamide resin, and thus it is possible to impart better functions. According to a third embodiment of the present invention, which corresponds to this preferred embodiment, in the method for producing a resin-based composite material according to the second embodiment of the present invention, it is characterized in that the dispersant is TAIC.

The resin-based composite material produced the method described above is usually molded and, preferably, crosslinked by heating, ionizing radiation irradiation, or the like. Thereby, a molded body having excellent physical properties is obtained. In particular, the method is suitably applied to production of an optical lens which is obtained by molding a resin-based composite material in which a thermally conductive filler is nano-dispersed in a transparent resin and which has excellent transparency and light stability. Description will be made below on production of an optical lens as an example of application of the method of the present invention.

Optical lenses made of a transparent resin, such as a transparent polyamide resin or fluororesin, are lightweight, difficult to break, and readily molded, compared with optical lenses composed of inorganic glass, and because of these features, they are widely used for various optical instruments. The optical lenses made of a resin are required to have high transparency equal to that of optical lenses made of glass, and also required to have a property of not being discolored by light irradiation during use (light stability).

In particular, in the case where optical lenses made of a resin are used for a light-emitting apparatus, such as a stroboscope, in which a xenon lamp, LED, blue-violet laser, or the like is used as a light source, and the light irradiation amount is large, discoloration, deformation, aging, or the like is likely to occur in the optical lenses made of a resin. Furthermore, in recent stroboscopes, an increase in the amount of light and a shortening in the light emission interval have been desired, and a reduction in the space between the light source and the lenses has been desired in order to cope with stroboscopes being increasingly built into other devices and reduced in size. Consequently, optical lenses made of a resin having excellent light stability, in which even if irradiated many times with a larger amount of light, foaming or discoloration does not occur, have been desired.

As the resin material for producing optical lenses having excellent transparency and excellent light stability, the transparent polyamide resin and the fluororesin disclosed in Japanese Unexamined Patent Application Publication No. 9-137057, in particular, the transparent polyamide resin, which is a condensation polymer of 1,10-decanedicarboxylic acid and 3,3′-dimethyl-4,4′-diaminodicyclohexylmethane, disclosed in International Publication No. WO2009/084690, and the like can be exemplified.

By nano-dispersing a thermally conductive filler in these transparent resins to improve a heat-dissipating property, it is possible to obtain optical lenses having excellent light stability so as to satisfy the recent requirement described above. Accordingly, the production method of the present invention is suitably used for producing an optical lens that satisfies the recent requirement by nano-dispersing a thermally conductive filler in a transparent resin. A fourth or fifth embodiment of the present invention, which will be described below, is suitably used for producing an optical lens.

According to the fourth embodiment of the present invention, in the method for producing a resin-based composite material according to any one of the first to third embodiments of the present invention, it is characterized in that the crosslinkable thermoplastic resin is a transparent polyamide resin.

As the transparent resin used for producing optical lenses, transparent resins composed of an acrylic resin, polycarbonate, polyolefin, fluororesin, polyamide, silicone, epoxy, polyimide, polystyrene, polyester, or the like can be exemplified. Among them, a transparent polyamide resin is preferable. In the fourth embodiment of the present invention, the method for producing a resin-based composite material according to the first embodiment of the present invention is applied to a case where the resin is a transparent polyamide resin.

According to the fifth embodiment of the present invention, in the method for producing a resin-based composite material according to any one of the first to fourth embodiments of the present invention, it is characterized in that the nano-filler is a thermally conductive filler.

By dispersing a thermally conductive filler in the resin, the heat-dissipating property of a molded body (transparent resin molded product) composed of the resulting resin-based composite material can be improved. According to the production method of the present invention, since the thermally conductive filler can be dispersed in the transparent resin with excellent dispersibility at a high concentration, the heat-dissipating property can be further improved.

Therefore, when the production method is used for producing an optical lens, the resulting optical lens has an excellent heat-dissipating property. Consequently, it is possible to obtain a molded body (optical lens) having excellent light stability in which even if irradiated many times with a larger amount of light, an increase in temperature can be suppressed, and discoloration or foaming is unlikely to occur.

According to a sixth embodiment of the present invention, there is provided a method for producing a resin molded product, characterized by including a step of obtaining a resin-based composite material by uniformly mixing a dispersion, which is prepared by nano-dispersing a nano-filler in a liquid dispersant, with a crosslinkable thermoplastic resin, and a step of molding the resulting resin-based composite material.

By molding the resin-based composite material produced by the method for producing a resin-based composite material according to the present invention, it is possible to obtain a resin molded product having an excellent function due to nano-dispersion of the nano-filler. For example, it is possible to obtain a resin molded product to which a function, such as a decrease of water absorption, a decrease of coefficient of expansion, improvement in thermal conductivity, improvement in refractive index, improvement in electrical conductivity (improvement in electromagnetic shielding property), or flame retardance, is imparted. Excellent dimensional stability can be obtained by a decrease of water absorption. Excellent stability in physical properties and dimension and excellent stability against a change in environment are obtained by a decrease of coefficient of linear expansion. It is also possible to produce a molded body having excellent adhesion with a metal insert.

According to a seventh embodiment of the present invention, there is provided a method for producing a crosslinked resin molded product, characterized by including molding a resin-based composite material obtained by uniformly mixing a dispersion, which is prepared by nano-dispersing a nano-filler in a liquid dispersant, with a crosslinkable thermoplastic resin, and then crosslinking the resin.

By molding the resin-based composite material produced by the method for producing a resin-based composite material according to the present invention, and crosslinking the matrix resin, it is possible to produce a molded body which has an excellent function due to nano-dispersion of the nano-filler and which is excellent in terms of heat resistance, heat resistance during reflow soldering process, and rigidity at high temperatures.

Furthermore, liquid bleedout can be prevented by crosslinking. That is, in the case where a liquid, such as a dispersant, is contained in a resin-based composite material, bleedout of the liquid may occur during use of a molded body made from the resin-based composite material, which is a problem. The bleedout is suppressed by crosslinking the matrix resin. Consequently, in the production of the resin-based composite material, a larger amount of the dispersant (liquid) can be mixed, and the concentration of the nano-filler nano-dispersed in the matrix resin can be increased. Therefore, the desired function can be further improved.

Molding of the resin-based composite material is preferably performed before crosslinking the resin. Since the rigidity of the resin-based composite material is low before crosslinking, molding can be easily performed. Furthermore, since heat resistance and rigidity can be improved by crosslinking, it is possible to obtain a molded body having excellent heat resistance and rigidity at high temperatures.

### Advantageous Effects of Invention

By the method for producing a resin-based composite material according to the present invention, a nano-filler can be easily nano-dispersed in a crosslinkable thermoplastic resin, and consequently, a resin-based composite material to which an excellent function is imparted can be easily obtained. By the method for producing a resin molded product or a crosslinked resin molded product according to the present invention, it is possible to produce a molded body which has an excellent function imparted by nano-dispersion of the nano-filler and which is excellent in terms of dimensional stability, heat resistance, rigidity, or the like.

### DESCRIPTION OF EMBODIMENTS

Specific embodiments of the present invention will be described below. Note that the present invention is not limited to the embodiments described herein.

As the liquid dispersant used in the production method of the present invention, a crosslinking agent, a plasticizer, a UV/EB monomer, and the like can be exemplified. Examples of the crosslinking agent that can be used as the liquid dispersant include, in addition to TAIC, oximes, such as p-quinone dioxime and p,p′-dibenzoyl quinone dioxime; acrylates or methacrylates, such as ethylene dimethacrylate, polyethylene glycol dimethacrylate, trimethylolpropane trimethacrylate, cyclohexyl methacrylate, an acrylic acid/zinc oxide mixture, allyl methacrylate, and trimethacryl isocyanurate; vinyl monomers, such as divinylbenzene, vinyl toluene, and vinyl pyridine; allyl compounds, such as hexamethylene diallyl nadiimide, diallyl itaconate, diallyl phthalate, diallyl isophthalate, diallyl monoglycidyl isocyanurate, and triallyl cyanurate; and maleimide compounds, such as N,N′-m-phenylenebismaleimide and N,N′-(4,4′-methylenediphenylene)dimaleimide. TAIC and these crosslinking auxiliaries may be used alone or in combination.

In the case where a transparent polyamide is used as the crosslinkable thermoplastic resin and TAIC, which is a crosslinking agent, is used as the dispersant, the amount of TAIC used is preferably less than 25 parts by weight, more preferably 1 to 20 parts by weight, relative to 100 parts by weight of the transparent polyamide. As the amount of TAIC used increases, the effect of promoting crosslinking to improve heat resistance during reflow soldering process and the like increases. However, when the amount of TAIC used exceeds the range described above, solidification during molding slows excessively to degrade moldability, and as a result, it may become difficult to obtain good appearance of the molded body in some cases.

Examples of the plasticizer that can be used as the liquid dispersant include known resin plasticizers, such as silicone and ester oils.

Examples of the UV/EB monomer that can be used as the liquid dispersant include acrylate-based monomers, methacrylate-based monomers, imide-based monomers, silicone-based monomers, urethane-based monomers, isocyanate-based monomers, and epoxy-based monomers.

As the transparent polyamide resin that can be used when the method of the present invention is applied to production of optical lenses, those exemplified in International Publication No. WO2009/084690 and the like may be used. In particular, a transparent polyamide resin which is amorphous and has a high glass transition temperature, such as the one described and exemplified in International Publication No. WO2009/084690, is suitable.

Examples of such a transparent polyamide resin include a resin obtained by condensation of a specific diamine and a specific dicarboxylic acid, a resin obtained by ring opening polymerization of a lactam, and a resin obtained by condensation of ω-aminocarboxylic acid. Above all, those having an aromatic ring, an alicyclic ring, or the like are preferable. In particular, a condensation polymer of 1,10-decanedicarboxylic acid and 3,3′-dimethyl-4,4′-diaminodicyclohexylmethane is preferable because discoloration, deformation, or the like is not likely to occur.

The transparent polyamide resin may be a blend of many different polyamides as long as the blend is transparent, and the blend may contain a crystalline polyamide. Furthermore, a transparent polyamine, which is produced by performing synthesis (polymerization) using starting monomers in the presence of a stabilizer, which will be described later, a reinforcement material, or the like, may be used.

As the transparent polyamide, a commercially available product may be used. For example, a polyamide, which is a condensation polymer of 1,10-decanedicarboxylic acid and 3,3′-dimethyl-4,4′-diaminodicyclohexylmethane, is commercially available under the trade name of Grilamid TR-90 (EMS-CHEMIE (Japan) Ltd.) or the like.

Other specific examples of the commercially available transparent polyamide that can be used in the present invention include TROGAMID CX7323, TROGAMID T, and TROGAMID CX9701 (trade names, which are manufactured by Daicel-Degussa Ltd.), Grilamid TR-155, Grivory G21, Grilamid TR-55LX, and Grilon TR-27 (which are manufactured by EMS-CHEMIE (Japan) Ltd.), Cristamid MS 1100 and Cristamid MS 1700 (which are manufactured by Arkema), and Selar 3030E, Selar PA-V2031,and Isoamid PA-7030 (which are manufactured by DuPont).

In the case where the method of the present invention is used for producing an optical lens, the thermally conductive filler that is suitably used as the nano-filler is defined as a filler having a thermal conductivity of 1 W/m·K or more, preferably, a filler having a thermal conductivity of 20 W/m·K or more, and more preferably, a filler having a thermal conductivity of 50 W/m·K or more. In the case of a nano-filler having a thermal conductivity of less than 1 W/m·K, even if a large amount of the nano-filler is added to the transparent resin, excellent light stability cannot be obtained, and foaming or discoloration occurs when irradiated many times with a large amount of light from a xenon lamp, LED, (blue-violet) laser, or the like.

Examples of the thermally conductive filler include alumina, (crystalline) silica, aluminum nitride, boron nitride, silicon nitride, zinc oxide, tin oxide, magnesium oxide, silicon carbide, carbon materials, such as carbon black, carbon fibers, and carbon nanotubes, and synthetic magnesite. The shape of the thermally conductive filler is not necessarily spherical, but the thermally conductive filler may be a rod-like, plate-like, or pulverized filler. Furthermore, the thermally conductive fillers may be subjected to surface treatment with a surfactant or the like in order to facilitate nano-dispersion thereof.

In the case where a resin-based composite material for forming an optical lens is produced, the addition amount of the thermally conductive filler is preferably 1% by weight or more relative to the weight of the transparent polyamide resin. When the addition amount is less than 1% by weight, improvement in the heat-dissipating property is insufficient, an optical lens having excellent light stability cannot be obtained, and foaming or discoloration occurs when irradiated many times with a large amount of light from a xenon lamp, LED, laser, or the like. On the other hand, when the addition amount exceeds 50% by weight, transparency may be degraded in some cases. Therefore, the addition amount is preferably 50% by weight or less. In order to obtain higher transparency, the addition amount is preferably 20% by weight or less.

When the thermally conductive filler is nano-dispersed in the transparent resin, the degree of nano-dispersion of the filler is strongly correlated with transparency. Accordingly, the degree of nano-dispersion of the filler can be expressed by the degree of transparency (total light transmission) of the resulting resin-based composite material or molding composition. In the case where a transparent polyamide resin is used as the matrix resin, according to the present invention, the thermally conductive filler can be nano-dispersed such that the total light transmission is 30% or more when the thickness of the molded body is set at 2 mm.

In the method for producing a resin-based composite material according to the present invention, as the method of nano-dispersing a nano-filler in the dispersant, a method in which dispersion is performed using a ball mill, a triple roll mill, or an agitating propeller can be exemplified.

In the method for producing a resin-based composite material according to the present invention, as the method of mixing a dispersion, which is prepared by nano-dispersing a nano-filler, with a crosslinkable thermoplastic resin, a known method employed in mixing a resin with a liquid may be used. For example, a method may be used in which a dispersion, a matrix resin, and other components added as necessary, which will be described later, are mixed using a known mixer, such as a single screw extruder, a twin screw extruder, or a pressure kneader. Furthermore, a method in which a dispersion, a monomer constituting a resin, a polymerization initiator, and other components added as necessary, which will be described later, are mixed to polymerize the monomer is also included in the step of mixing the dispersion with the crosslinkable thermoplastic resin according to the present invention.

Among the mixers described above, a twin screw extruder is preferable in the case where the production method is used for producing an optical lens. In the case where a thermally conductive filler is dispersed in a transparent polyamide resin, a mixing temperature of about 230° C. to 300° C. and a mixing time of about 2 seconds to 15 minutes are generally preferably employed.

The resin-based composite material produced according to the present invention may be incorporated with, in addition to the nano-filler, the liquid dispersant, and the matrix resin, other components within the range that does not impair the object of the present invention. For example, a stabilizer, a copper inhibitor, a flame retardant, a lubricant, a conducting agent, a plating agent, and the like can be added.

In particular, in the case of a resin-based composite material for forming an optical lens in which a thermally conductive filler is dispersed in a transparent polyamide resin, incorporation of a stabilizer is preferable. By incorporating a stabilizer, discoloration of the optical lens can be more effectively suppressed. Specific examples of the stabilizer include a hindered amine light stabilizer, an ultraviolet absorber, a phosphorus-based stabilizer, a hindered phenol-based antioxidant, and a hydroquinone-based antioxidant. When two or more stabilizers are used in combination, the function as stabilizer may be improved, resulting in a higher effect in some cases.

As the stabilizer, a commercially available stabilizer can be used. For example, the hindered amine light stabilizer is commercially available as ADEKA STAB LA68 or LA62 (trade name, ADEKA Corporation), or the like, the ultraviolet absorber is commercially available as ADEKA STAB LA36 (trade name, ADEKA Corporation) or the like, the phosphorus-based stabilizer is commercially available as Irgafos 168 (trade name, BASF) or the like, the hindered phenol-based antioxidant is commercially available as Irganox 245 or Irganox 1010 (trade name, BASF), or the like, and the hydroquinone-based antioxidant is commercially available as Methoquinone (trade name, Seiko Chemical Co., Ltd.) or the like. These products can be used.

The molding method used in the molding step of the method for producing a resin molded product or a crosslinked resin molded product according to the present invention is not particularly limited. For example, an injection molding method, an injection compression molding method, a press molding method, an extrusion molding method, a blow molding method, a vacuum forming method, or the like may be employed. From the standpoint of ease of molding and accuracy of molding, an injection molding method is preferable.

In the method for producing a crosslinked resin molded product according to the present invention, the resin is crosslinked by a method in which the resin is heated, irradiated with ionizing radiation, or the like. In particular, the method of irradiation with ionizing radiation is preferable from the viewpoint of ease of control. As the ionizing radiation, use of electron beams is preferable from the viewpoint of safety, ready availability of apparatus, and the like.

As described above, by crosslinking the resin, the rigidity of the resin can be improved. In the case where the crosslinked resin molded product is used as an optical lens, the storage elastic modulus at 270° C. of the molded body is preferably set to be 0.1 MPa or more by crosslinking. By setting the storage elastic modulus at 270° C. to be 0.1 MPa or more, it is possible to obtain satisfactory rigidity at from room temperature to high temperatures. Thus, when the optical lens is mounted by soldering using lead-free solder or reflow soldering, and even when the temperature of the usage environment of the optical lens increases, the problem of thermal deformation is unlikely to occur, and the so-called heat resistance during reflow soldering process is high, which is preferable.

Herein, the storage elastic modulus is a part (real part) of a complex elastic modulus, which represents the relation between stress and strain when sinusoidally-varied vibrational strain is applied to a viscoelastic body, and is a value measured by a viscoelasticity measuring instrument (DMS). More specifically, the storage elastic modulus is a value measured by a viscoelasticity measuring instrument, i.e., DVA-200 manufactured by IT Keisoku Seigyo, Co. Ltd., at a rate of temperature increase of 10° C./min from room temperature (25° C.).

### EXAMPLES

The present invention will now be described on the basis of examples. It is to be understood that the present invention is not limited to the examples described herein, and the embodiments can be changed and modified without departing from the scope and spirit of the present invention. First, description will be made on starting materials used in Example and Comparative Examples.

[Transparent polyamide] Condensation polymer of 1,10-decanedicarboxylic acid and 3,3′-dimethyl-4,4′-diaminodicyclohexylmethane (trade name: Grilamid TR-90, manufactured by EMS-CHEMIE (Japan) Ltd.)

[Crosslinking agent] Triallyl isocyanurate (TAIC, manufactured by Nippon Kasei Chemical Co., Ltd.)

[Thermally conductive filler] Titanium oxide (trade name: TTO-51A, manufactured by Ishihara Sangyo Kaisha, Ltd.)

### EXAMPLE

A resin composition having the composition shown in Table was obtained as follows: That is, TAIC (in a liquid state) and a thermally conductive filler were mixed in an alumina ball mill, and thereby, a dispersion in which the thermally conductive filler was nano-dispersed in TAIC was obtained. The resulting dispersion was side-fed into a twin screw mixer (Toshiba Machine Co., Ltd. TEM58BS) and mixed with the transparent polyamide. Thereby, a resin-based composite material of the present invention was obtained.

The resin-based composite material thus obtained was subjected to injection molding using a SE-18 (manufactured by Sumitomo Heavy Industries, Ltd., electric injection molding machine) to produce a molded body sample with dimensions of 40 mm×40 mm×2 mm (thickness). The injection molding was performed at a resin temperature of 280° C., at a mold temperature of 80° C., and at a cycle of 30 seconds.

The resulting molded body sample was irradiated with electron beams at 300 kGy to perform crosslinking. Thereby, a crosslinked resin molded product of the present invention was obtained. The total light transmission and appearance after light stability test were measured on the molded body after irradiation by the methods described below. The results are shown in Table.

### Comparative Example 1

With the composition shown in Table, TAIC was side-fed into a twin screw mixer (Toshiba Machine Co., Ltd. TEM58BS) and mixed with the transparent polyamide. Then, using a SE-18 (manufactured by Sumitomo Heavy Industries, Ltd., electric injection molding machine), injection molding was performed under the same conditions as those in Example to produce a molded body sample with dimensions of 40 mm×40 mm×2 mm (thickness). Furthermore, under the same conditions as those in Example, the resulting molded body sample was irradiated with electron beams to perform crosslinking. Thereby, a crosslinked resin molded product was obtained. The total light transmission and appearance after light stability test were measured on the molded body after irradiation by the methods described below.

### Comparative Example 2

With the composition shown in Table, TAIC, a thermally conductive filler, and the transparent polyamide were fed from the top into a twin screw mixer (Toshiba Machine Co., Ltd. TEM58BS), and mixing was performed. Then, using a SE-18 (manufactured by Sumitomo Heavy Industries, Ltd., electric injection molding machine), injection molding was performed under the same conditions as those in Example to produce a molded body sample with dimensions of 40 mm×40 mm×2 mm (thickness). Furthermore, under the same conditions as those in Example, the resulting molded body sample was irradiated with electron beams to perform crosslinking. Thereby, a crosslinked resin molded product was obtained. The total light transmission and appearance after light stability test were measured on the molded body after irradiation by the methods described below. The results are shown in Table.

[Total Light Transmission]

Measurement was performed in accordance with JIS K 7361. The ratio between the incident light amount T₁ and the total amount T₂ of light passed through a specimen, in the visible light range (in the wavelength range of 400 to 800 nm), is expressed in percentage.

[Appearance after Light Stability Test]

Using a commercially available external stroboscope (manufactured by Nikon Corporation), with the distance between the surface of a crosslinked resin molded product and a light source (xenon lamp) being set to 2 mm, flashing under the following conditions was repeated 200 cycles, in a cycle of once in 10 seconds or once in 2 seconds. Flashing time: (1/800) seconds, color temperature: 5,600 K

Discoloration of the lens after 200 cycles was evaluated. The evaluation results are shown in Table, in which the circle (◯) indicates that no discoloration is observed in the lens, and the cross mark (×) indicates that the central portion of the lens is discolored.

TABLE

| | | | Comparative | Comparative |
|---|---|---|---|---|
| | | Example | Example 1 | Example 2 |
| Resin | Transparent polyamide | 100 | 100 | 100 |
| compo- | resin: TR-90 | | | |
| sition | Crosslinking auxiliary: | 15 | 15 | 15 |
| | TAIC | | | |
| | Thermally conductive | 10 | 0 | 10 |
| | filler: TTO-51A | | | |

| Total light transmission (%) | | 80 | 90 | 20 |
|---|---|---|---|---|
| Appearance | Flashing once | ◯ | ◯ | ◯ |
| after light- | in 10 sec | | | |
| fastness test | Flashing once | ◯ | X | X |
| | in 2 sec | | | |

As is evident from the results shown in Table, in Example 1 in which a dispersion is prepared by nano-dispersing the thermally conductive filler in TAIL, and the dispersion is mixed with the transparent polyamide resin, the total light transmission is 80%, indicating that the thermally conductive filler is nano-dispersed in the transparent polyamide resin. Furthermore, the appearance after light stability test, in the case of flashing once in 2 seconds, is good. The reason for this is believed to be that since the thermally conductive filler is nano-dispersed, the heat-dissipating property is improved.

On the other hand, in Comparative Example 1, in which a thermally conductive filler is not dispersed, the appearance after light stability test, in the case of flashing once in 2 seconds, is poor. The reason for this is believed to be that since the heat-dissipating property is not improved, an increase in temperature due to many times of flashing is large. Furthermore, in Comparative Example 2, in which although a thermally conductive filler is dispersed, the thermally conductive filler together with TAIC is directly mixed in the matrix resin, without preparing a dispersion, the total light transmission is 20%, indicating that the dispersibility of the thermally conductive filler is low. Furthermore, the appearance after light stability test, in the case of flashing once in 2 seconds, is poor. The reason for this is believed to be that since the dispersibility of the thermally conductive filler is low, the heat-dissipating property is not improved, and an increase in temperature due to many times of flashing is large.

### INDUSTRIAL APPLICABILITY

The present invention can be used for producing a crosslinked resin in which various physical properties are improved by nano-dispersing a nano-filler in a crosslinkable thermoplastic resin, and for producing a molded body thereof. In particular, the invention can be used for producing an optical lens suitable for use in the application of a lens for stroboscope (for example, a Fresnel lens for stroboscope) and the like.

1. A method for producing a resin-based composite material, characterized by comprising a step of uniformly mixing a dispersion, which is prepared by nano-dispersing a nano-filler in a liquid dispersant, with a crosslinkable thermoplastic resin.

2. The method for producing a resin-based composite material according to claim 1, characterized in that the dispersant is a crosslinking agent, a plasticizer, or a monomer that is polymerizable by ultraviolet light or electron beam irradiation, which is in a liquid state at a temperature higher than the glass transition temperature of the crosslinkable thermoplastic resin by 50° C.

3. The method for producing a resin-based composite material according to claim 2, characterized in that the dispersant is triallyl isocyanurate.

4. The method for producing a resin-based composite material according to claim 1, characterized in that the crosslinkable thermoplastic resin is a transparent polyamide resin.

5. The method for producing a resin-based composite material according to claim 1, characterized in that the nano-filler is a thermally conductive filler.

6. A method for producing a resin molded product, characterized by comprising:
a step of obtaining a resin-based composite material by uniformly mixing a dispersion, which is prepared by nano-dispersing a nano-filler in a liquid dispersant, with a crosslinkable thermoplastic resin; and
a step of molding the resulting resin-based composite material.

7. A method for producing a crosslinked resin molded product, characterized by comprising molding a resin-based composite material obtained by uniformly mixing a dispersion, which is prepared by nano-dispersing a nano-filler in a liquid dispersant, with a crosslinkable thermoplastic resin, and then crosslinking the resin.
